(19) United States
(12) Patent Application Publication
(10) Pub. No.: US 2020/0281021 A1
(43) Pub. Date: Sep. 3, 2020

(54) SYSTEMS AND METHODS FOR CONTROL SIGNALING OF XPRACH

(71) Applicant: INTEL IP CORPORATION, Santa Clara, CA (US)

(72) Inventors: Yushu Zhang, Beijing (CN); Wenting Chang, Beijing (US); Yuan Y. Zhu, Beijing (CN); Xiaogang Chen, Portland, OR (US); Quinghua Li, San Ramon, CA (US)

(73) Assignee: INTEL IP CORPORATION, Santa Clara, CA (US)

(21) Appl. No.: 16/074,398

(22) PCT Filed: Apr. 26, 2016
(86) PCT No.: PCT/CN2016/080231

§ 371 Date: Jul. 31, 2018

(51) Int. Cl. H04W 74/08; H04B 7/08; H04L 5/00; H04W 74/00; H04W 76/27

(52) U.S. Cl. CPC H04W 74/0833; H04B 7/088; H04W 76/27; H04W 74/006; H04L 5/0053

(57) ABSTRACT

The present disclosure includes systems and methods for triggering xPRACH transmissions. Control information is obtained from a first evolved Node B (eNB). The control information includes at least one random access parameter. A random access preamble index is determined based on the at least one random access parameter. A random access preamble is generated for a second eNB based on the random access preamble index.

### TECHNICAL FIELD

The present disclosure relates to the physical random access channel (PRACH).

### BRIEF DESCRIPTION OF THE DRAWINGS

FIG. 1 illustrates an example of an environment in which the present systems and methods may be implemented.

FIG. 2 is a block diagram illustrating one example of control information that includes xPRACH information.

FIG. 3 is a swim diagram illustrating one example of the communications between a UE and an eNB.

FIG. 4 is a swim diagram illustrating another example of the communications between a UE and an eNB.

FIG. 5 is a swim diagram illustrating one example of the communications between a UE, a source eNB, and a target eNB.

FIG. 6 is a flow diagram of a method for wireless communication by a UE.

FIG. 7 is a flow diagram of a method for wireless communication by a source eNB.

FIG. 8 is a flow diagram of a method for wireless communication by a target eNB.

FIG. 9 is a block diagram illustrating electronic device circuitry that may be UE circuitry, network node circuitry, or some other type of circuitry in accordance with various embodiments.

FIG. 10 is a block diagram illustrating electronic device circuitry that may be eNB circuitry, network node circuitry, or some other type of circuitry in accordance with various embodiments.

FIG. 11 is a block diagram illustrating, for one embodiment, example components of a user equipment (UE) or mobile station (MS) device.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Wireless mobile communication technology uses various standards and protocols to transmit data between a base station and a wireless mobile device. Wireless communication system standards and protocols can include the 3rd Generation Partnership Project (3GPP) long term evolution (LTE); the Institute of Electrical and Electronics Engineers (IEEE) 802.16 standard, which is commonly known to industry groups as worldwide interoperability for microwave access (WiMAX); and the IEEE 802.11 standard, which is commonly known to industry groups as Wi-Fi. In 3GPP radio access networks (RANs) in LTE systems, the base station can include Evolved Universal Terrestrial Radio Access Network (E-UTRAN) Node Bs (also commonly denoted as evolved Node Bs, enhanced Node Bs, eNodeBs, or eNBs) and/or Radio Network Controllers (RNCs) in an E-UTRAN, which communicate with a wireless communication device, known as user equipment (UE).

A common goal in cellular wireless networks (such as 3GPP networks) includes efficient use of licensed bandwidth. One way that a UE, or other mobile wireless devices, can more efficiently use bandwidth is through space-division multiple access (SDMA). For example, multiple-input multiple-output (MIMO) technologies can be used to multiply the capacity of a radio link by exploiting multipath propagation. In another example, multi-user MIMO (MU-MIMO) technologies can be used to transmit/receive to multiple users at the same time and on the same frequency resources by using different spatial signatures

In 5th Generation (5G) LTE it is anticipated that large number of devices (e.g., Internet of Things (IOT), sensors, wearables, etc.) may primarily utilize uplink resources to provide data to a network (e.g., E-UTRAN). To accommodate a large number of these primarily uplink devices, techniques such as massive multi-user multiple-input multiple-output (MU-MIMO) may be used. The Physical Random Access Channel (PRACH), referred to as the xPRACH in 5G LTE, may be used for initial access, uplink synchronization, handover, and so on. In massive MU-MIMO systems, the xPRACH may also be used for uplink receive beam scanning.

In many cases, it may be beneficial to signal a UE to make an xPRACH transmission. For example, in the case of MU-MIMO, it may be beneficial for an eNB to instruct the UE to make an xPRACH transmission. One way in which control signaling for xPRACH can be sent, is via the LTE network (e.g., via radio resource control (RRC) messages, downlink control information (DCI), etc.). However, the latency associated with this approach is quite large and the system may not be able to work in a stand-alone manner with this approach.

For cell-less operation, uplink beam aggregation, uplink dynamic point selection, and handover, it may be beneficial to transmit the xPRACH to different eNBs for the timing advance (TA) estimation and/or uplink beam scanning. This disclosure considers various designs of control signaling for the xPRACH transmission. For example, the present disclosure proposes various systems and methods of control signaling for xPRACH transmission, including: uplink cell-less support, uplink beam aggregation support, uplink dynamic point selection support, and quick handover support.

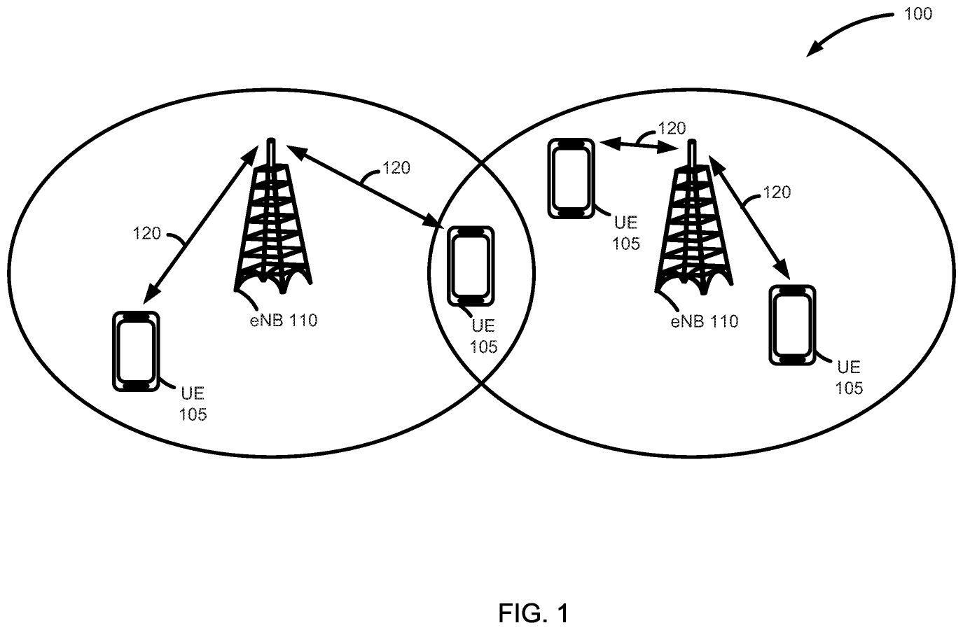

Turning now to the Figures, FIG. 1 illustrates an example of an environment 100 in which the present systems and methods may be implemented. The environment 100 includes multiple eNBs 110. In one example, the each of the multiple eNBs 110 may be part of the same E-UTRAN. In another example, at least one of the eNBs 110 is associated with a different RAN (e.g., a different E-UTRAN). One or more UEs 105 may be within the coverage area of an eNB 110 and may communicate with the eNB 110 via a cellular air interface 120 (such as an LTE/LTE-Advanced access link).

In MU-MIMO UE, multiple UEs 105 may use the same time/frequency resources. For example, various beam forming techniques may be used to facilitate MU-MIMO. MU-MIMO may be performed on the uplink and/or on the downlink. In one example, uplink MU-MIMO may be performed between a single eNB 110 and multiple UEs 105. In the case of uplink MU-MIMO, an eNB 110 may utilize multiple uplink receive (RX) beams to receive from multiple UEs 105 using the same time/frequency resources (e.g., using the same, although spatially diverse, resource blocks).

Typically the PRACH is used for initial access with the eNB 110. However, in the case of MU-MIMO and in other MIMO situations, the PRACH (e.g., xPRACH) can be used for configuring the MIMO connection. For example, an xPRACH transmission may be used by an eNB 110 to determine the RX beam that should be used for MU-MIMO communication. Additionally or alternatively, the xPRACH transmission (by the UE 105) may be used by the eNB 110 to determine/facilitate the determination of timing advance (TA). However, the xPRACH (an xPRACH preamble, for example) is typically only sent during initial access. However, it may be beneficial to utilize an xPRACH transmission at other times. For example, it may be desirable to adjust which RX beam(s) is/are being used, the TA that is being used, and/or the power control factors that are being used during a connection (e.g., RRC connected) with an eNB 110 and/or during handover between eNBs 110. In one example, the eNB 110 may send control information (e.g., RRC control information, DCI, MAC information, etc.) that includes xPRACH information (instructions for the UE 105 to transmit an xPRACH and the parameters for the xPRACH transmission, for example).

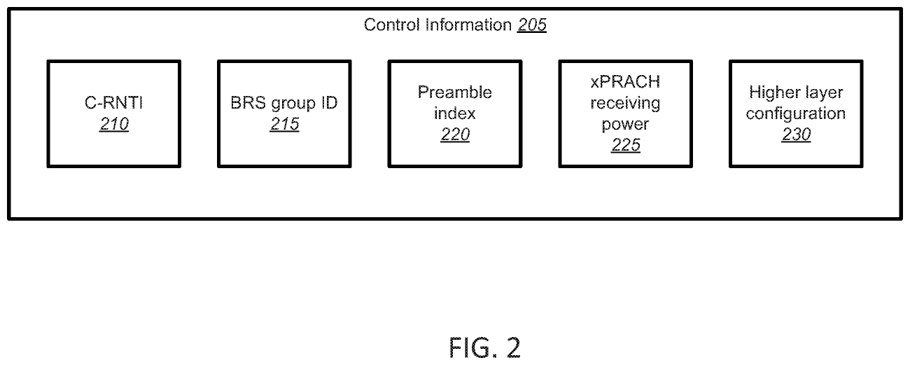

FIG. 2 is a block diagram illustrating one example of control information 205 that includes xPRACH information. The control information 205 may be an RRC message (e.g., an RRC connection reconfiguration message, handover message), DCI, MAC information, or any other type of control signaling. In addition to and/or in place of at least a part of the typical control information, the control information 205 may include xPRACH information. The xPRACH information may include one or more of a cell-specific radio network temporary identifier (C-RNTI) 210, a beam reference signal (BRS) group identifier (ID) 215, a preamble index 220, a xPRACH receiving power 225, and a higher layer configuration 225.

The C-RNTI 210 may be the C-RNTI of a currently connected eNB 110 or a new C-RNTI of a target eNB 110 that the UE is considering a possible handover to. Beam reference signals (BRS) may be grouped into a plurality of groups. The BRS group ID 215 may indicate the BRS group of the plurality of groups that should be used when determining the xPRACH preamble. The preamble index 220 may indicate the BRS (i.e., the preamble index) within the particular BRS group ID 215 that should be used when determining the xPRACH preamble. In this way, the eNB 110 may assign the UE 105 the xPRACH preamble that should be used in the xPRACH transmission.

The control information 205 may additionally or alternatively include an xPRACH receiving power 225 and/or higher layer configuration information 230. The xPRACH receiving power 225 is the receiving power that should be used when transmitting the xPRACH preamble. The higher layer configuration 230 may indicate further configuration parameters for configuring the xPRACH preamble.

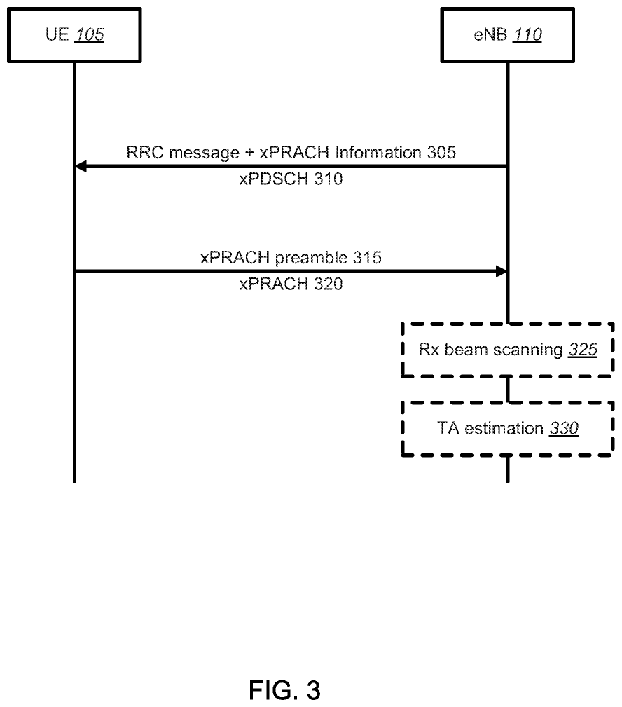

FIG. 3 is a swim diagram illustrating one example of the communications between a UE 105 and an eNB 110. In one example, the eNB 110 transmits an RRC message that includes xPRACH information 305 to the UE 105 over a physical downlink shared channel (PDSCH) 310 (e.g., xPDSCH). The RRC message 305 may be an RRC reconfiguration request message, an RRC handover message, or the like.

Using the xPRACH information in the RRC message 305, the UE 105 may generate an xPRACH preamble 315. For example, the UE 105 may use the BRS group ID 215 and the preamble index 220 to generate the xPRACH preamble 315. The UE 105 may transmit the generated xPRACH preamble 315 over the xPRACH 320.

Using the received xPRACH preamble 315, the eNB 110 may optionally perform RX beam scanning 325 and/or TA estimation 330. The xPRACH preamble 315 may include multiple copies of a preamble sequence (the preamble sequence determined based on the BRS group ID 215 and the preamble index 220, for example). For RX beam scanning 325, the eNB 110 may apply a different RX beam to each copy of the preamble sequence. The eNB 110 may compare the result of the different RX beams on the preamble sequence and may select one or more RX beams to use with the UE 105 for MU-MIMO communication. Additionally or alternatively, the eNB 110 may evaluate the timing of the xPRACH preamble 315 and may estimate timing advance information for the UE 105.

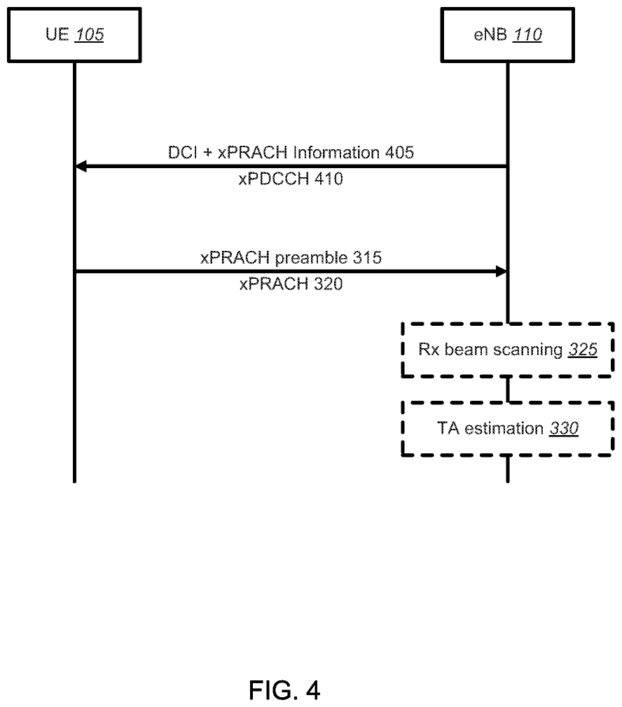

FIG. 4 is a swim diagram illustrating another example of the communications between a UE 105 and an eNB 110. In one example, the eNB 110 transmits downlink control information (DCI) that includes xPRACH information 405 to the UE 105 over a physical downlink control channel (PDCCH) 410 (e.g., xPDCCH).

Using the xPRACH information in the DCI 405, the UE 105 may generate an xPRACH preamble 315. For example, the UE 105 may use the BRS group ID 215 and the preamble index 220 to generate the xPRACH preamble 315. The UE 105 may transmit the generated xPRACH preamble 315 over the xPRACH 320.

Using the received xPRACH preamble 315, the eNB 110 may optionally perform RX beam scanning 325 and/or TA estimation 330. The xPRACH preamble 315 may include multiple copies of a preamble sequence (the preamble sequence determined based on the BRS group ID 215 and the preamble index 220, for example). For RX beam scanning 325, the eNB 110 may apply a different RX beam to each copy of the preamble sequence. The eNB 110 may compare the result of the different RX beams on the preamble sequence and may select one or more RX beams to use with the UE 105 for MU-MIMO communication. Additionally or alternatively, the eNB 110 may evaluate the timing of the xPRACH preamble 315 and may estimate timing advance information for the UE 105.

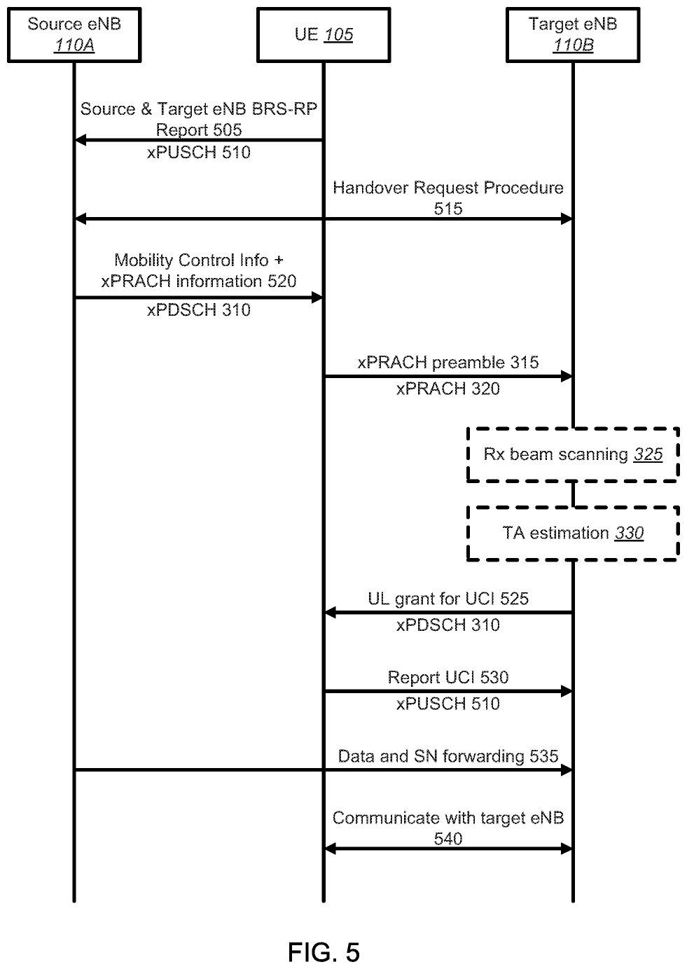

FIG. 5 is a swim diagram illustrating one example of the communications between a UE 105, a source eNB 110A, and a target eNB 110B. The source eNB 110A and the target eNB 110B may each be examples of eNB 110 illustrated in FIGS. 1-4. To add a new receiving eNB 110 or perform a handover procedure, the xPRACH should be transmitted to a target eNB 110B, where a new BRS group index 215 may be applied as well as the corresponding preamble index 220 for non-contention based xPRACH procedure. As illustrated in FIG. 5, the mobility control information includes xPRACH related information, which may be transmitted via the higher layer signaling.

Although not shown, the source eNB 110A may transmit a BRS to the UE 105. Additionally or alternatively, the target eNB 110B may transmit a BRS to the UE 105. The UE 105 may generate a source eNB 110A and target eNB 110B BRS report (BRS-RP) 505. The UE 105 transmits the BRS-RP 505 to the source eNB 110A over the physical uplink shared channel (PUSCH) 510 (e.g., xPUSCH). The source eNB 110A and the target eNB 110B engage in a handover request procedure 515. In some cases, the source eNB 110A receives parameters for xPRACH transmission to the target eNB 110B. For example, the target eNB 110B may provide the source eNB 110A with the target C-RNTI 210, a new BRS group ID 215, and/or a new preamble index 220.

The source eNB 110A may generate and transmit mobility control information 520 to the UE 105. The mobility control information 520 includes xPRACH information. 520. For example, the mobility control information 520 includes the target BRS group ID 215 and preamble index 220 within one preamble group (e.g., one BRS group ID). The BRS group ID 215 and the preamble index 220 can be used to determine the preamble sequence to be used for the xPRACH. For example, the preamble sequence can be determined according to equation (1).

Npreamble=G×N_{g}+K (1)

Where G denotes the value of the BRS group ID 215, N_{g} denotes the number of preamble indexes within one BRS group (can be predefined by the system, for example), and K denotes the preamble index 220 within the identified BRS group.

In one example, the BRS group ID 215 may contain 5 bits and the preamble index 220 may contain 2 bits for 14 groups with 4 non-contention preamble sequences in each group. Using the xPRACH information in the mobility control information 505, the UE 105 may generate an xPRACH preamble 315. For example, the UE 105 may use the BRS group ID 215 and the preamble index 220 to generate the xPRACH preamble 315. The UE 105 may transmit the generated xPRACH preamble 315 to the target eNB 110B over the xPRACH 320.

Using the received xPRACH preamble 315, the target eNB 110B may optionally perform RX beam scanning 325 and/or TA estimation 330. The target eNB 110B may generate an uplink grant for uplink control information (UCI) 525. The uplink grant 525 is transmitted on the xPDSCH 310. The UE 105, upon receiving the uplink grant 525, generates a UCI report 520. The UCI report 520 is transmitted to the target eNB 110B over the PUSCH 510. The source eNB 110A forwards data and configuration information 535 to the target eNB 110B. The handover procedure is completed and the UE 105 communicates 540 with the target eNB 110B. In this way, the target eNB 110B may quickly and efficiently perform RX beam scanning 325 and/or TA estimation 330 for cell-less support and quick handover support.

In one embodiment, the mobility control information may be an RRC message (e.g., a RRC connection reconfiguration request message). In another embodiment, the mobility control information may be DCI. In either case, the xPRACH information may indicate that the UE should perform an xPRACH transmission (transmission of multiple copies of a preamble sequence over the xPRACH, for example).

In one example, the xPRACH transmission happens at the first xPRACH transmission subframe after subframe n+g, where n is the subframe the DCI decoded and g is the decoding latency which can be pre-defined by the system. In some cases, the DCI indicating an xPRACH transmission may include the target BRS group ID 215, the preamble index 220 within one preamble group, the new C-RNTI 210, relative xPRACH receiving power for the target eNB 110B, and the target cell ID.

The relative xPRACH receiving power for the target eNB 110B may be used to quantize the xPRACH receiving power of target eNB 110B by limited bits. For example, 2 bits may be used to define the control information as in Table 1, where r, denotes the target xPRACH receiving power for the target eNB 110B and the r, indicates the target xPRACH receiving power for the source eNB 110A.

TABLE 1
Relative xPRACH receiving power indication

| Relative xPRACH receiving power | Indication for target xPRACH |
|---|---|
| for target eNB 110B | receiving power |
| 0 | −3 ≤ rₜ − rₛ ≤ 3 |
| 1 | rₜ − rₛ < −3 |
| 2 | 3 ≤ rₜ − rₛ ≤ 6 |
| 3 | rₜ − rₛ > 6 |

In the case that the new C-RNTI 210 is equal to the UE's current C-RNTI and the target BRS group ID 215 is equal to the current BRS group ID 215, the UE 105 may determine that the xPRACH transmission is for TA estimation 330 or the uplink beam scanning 325, which may be used for beam recovery.

In the case that the new C-RNTI 210 is equal to the UE's 105 current C-RNTI and the target BRS group ID 215 is not equal to the current BRS group ID, the UE 105 may determine that the xPRACH transmission is for the TA estimation 330 or the uplink beam scanning for another eNB and the UE 105 cannot disconnect to the current eNB.

In the case that the new C-RNTI 210 is not equal to the UE's 105 current C-RNTI, the UE 105 may determine that the xPRACH transmission is for a handover procedure and it can disconnect from the current eNB 110A and start the RRC connection establishment procedure with the target eNB 110B.

In another embodiment, the mobility control information may only contain the indication of target BRS group ID 215 and preamble index 220. In this case, the UE may determine that a 5G PDSCH 310 (e.g., xPDSCH) transmission is to be made.

In some embodiments, a pre-defined invalid value may be applied in the xPRACH information to indicate that xPRACH transmission is not granted. In one example, if the target BRS group ID 515 is equal to M, where M is the maximum number of BRS groups, the UE 105 may determine to not transmit the xPRACH (e.g., the xPRACH preamble).

If the PDSCH is decoded in discontinuous transmission (DTX) state, the eNB 110 may not receive the xPRACH in the n+g subframe. Instead, the eNB 110 may retransmit the DCI in the next subframe. In some embodiments, where the xPRACH transmission is used for the handover procedure, the radio access response (RAR) may only conclude the uplink grant for the message 3 (msg3). If this xPRACH transmission is used for the handover procedure, the RAR may conclude the following information—new C-RNTI, target cell ID, and/or uplink grant for msg3.

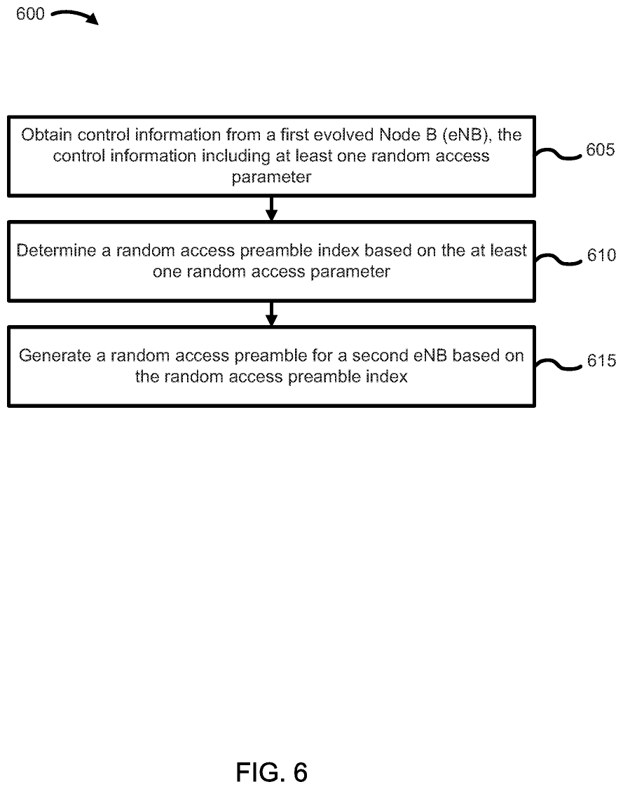

FIG. 6 is a flow diagram of a method 600 for wireless communication by a UE that supports MU-MIMO. The method 600 is performed by the UE 105 illustrated in FIGS. 1-5. Although the operations of method 600 are illustrated as being performed in a particular order, it is understood that the operations of method 600 may be reordered without departing from the scope of the method.

At 605, control information is obtained from a first eNB. The control information includes at least one random access parameter. At 610, a random access preamble index is determined based on the at least one random access parameter. At 615, a random access preamble for a second eNB is generated based on the random access preamble index.

The operations of method 600 may be performed by an application specific processor, programmable application specific integrated circuit (ASIC), field programmable gate array (FPGA), or the like.

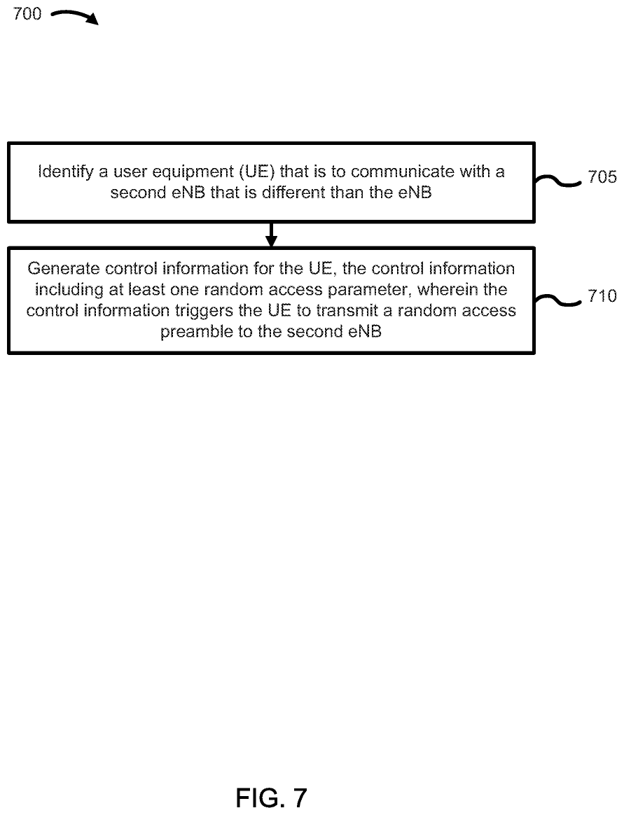

FIG. 7 is a flow diagram of a method 700 for wireless communication by an eNB that supports MU-MIMO. The method 700 is performed by the source eNB 110A illustrated in FIGS. 1-5. Although the operations of method 700 are illustrated as being performed in a particular order, it is understood that the operations of method 700 may be reordered without departing from the scope of the method.

At 705, a UE that is to communicate with a second eNB is identified. The second eNB is different than the first eNB. At 710, control information for the second UE is generated. The control information includes a random access parameter. The control information triggers the UE to transmit a random access preamble to the second eNB.

The operations of method 700 may be performed by an application specific processor, programmable application specific integrated circuit (ASIC), field programmable gate array (FPGA), or the like.

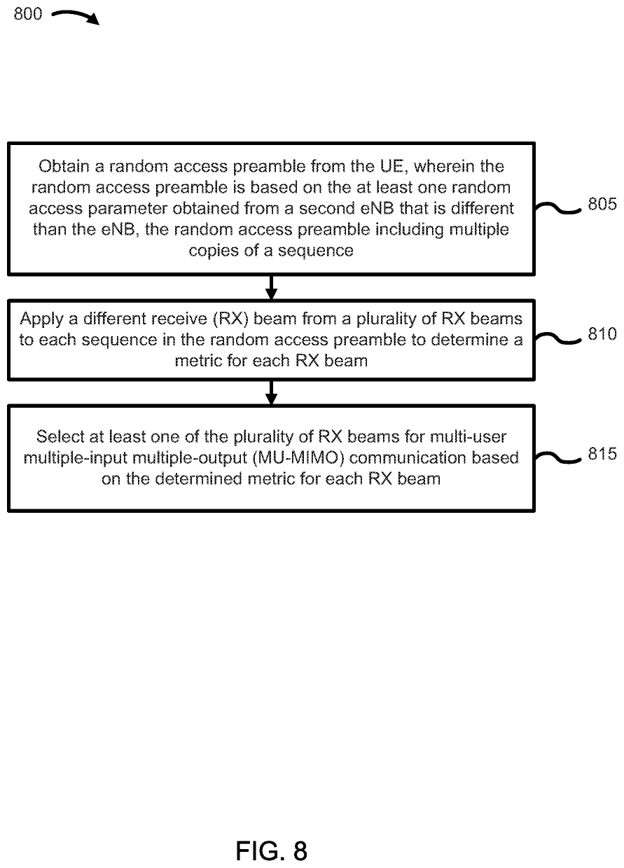

FIG. 8 is a flow diagram of a method 800 for wireless communication by an eNB. The method 800 is performed by the target eNB 110B illustrated in FIG. 5. Although the operations of method 800 are illustrated as being performed in a particular order, it is understood that the operations of method 800 may be reordered without departing from the scope of the method.

At 805, a random access preamble is obtained from the UE. The random access preamble is based on the at least one random access parameter obtained from a second eNB that is different than the eNB. The random access preamble includes multiple copies of a sequence. At 810, a different RX beam from a plurality of RX beams is applied to each sequence in the random access preamble to determine a metric for each RX beam. At 815, at least one of the plurality of RX beams is selected for MU-MIMO communication based on the determined metric for each RX beam.

The operations of method 800 may be performed by an application specific processor, programmable application specific integrated circuit (ASIC), field programmable gate array (FPGA), or the like.

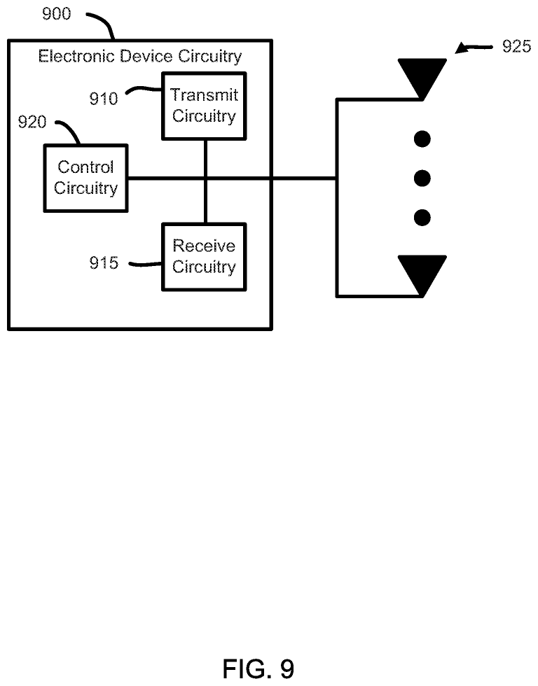

FIG. 9 is a block diagram illustrating electronic device circuitry 900 that may be UE circuitry, network node circuitry, or some other type of circuitry in accordance with various embodiments. In embodiments, the electronic device circuitry 900 may be, or may be incorporated into or otherwise a part of a UE (e.g., UE 105), a mobile station (MS), a BTS, a network node, or some other type of electronic device. In embodiments, the electronic device circuitry 900 may include radio transmit circuitry 910 and receive circuitry 915 coupled to control circuitry 920 (e.g., baseband processor(s)). In embodiments, the transmit circuitry 910 and/or receive circuitry 915 may be elements or modules of transceiver circuitry, as shown. In some embodiments, the control circuitry 920 can be in a device separate from the transmit circuitry 910 and the receive circuitry 915 (baseband processors shared by multiple antenna devices, as in cloud-RAN (C-RAN) implementations, for example). The electronic device circuitry 900 may be coupled with one or more plurality of antenna elements 925 of one or more antennas. The electronic device circuitry 900 and/or the components of the electronic device circuitry 900 may be configured to perform operations similar to those described elsewhere in this disclosure.

In embodiments where the electronic device circuitry 900 is or is incorporated into or otherwise part of a UE, the transmit circuitry 910 can transmit the various described information (e.g., xPUCCH, xPUSCH) to the eNB. The receive circuitry 915 can receive the various described information (e.g., mobility control information, RRC message, DCI) from the eNB. In certain embodiments, the electronic device circuitry 900 shown in FIG. 9 is operable to perform one or more methods, such as the methods shown in FIG. 6.

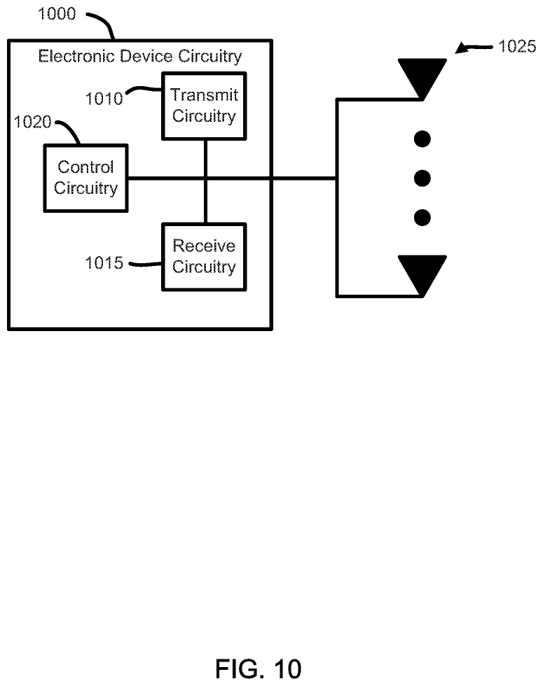

FIG. 10 is a block diagram illustrating electronic device circuitry 1000 that may be eNB circuitry, network node circuitry, or some other type of circuitry in accordance with various embodiments. In embodiments, the electronic device circuitry 1000 may be, or may be incorporated into or otherwise a part of, an eNB (e.g., eNB 110), a BTS, a network node, or some other type of electronic device. In embodiments, the electronic device circuitry 1000 may include radio transmit circuitry 1010 and receive circuitry 1015 coupled to control circuitry 1020 (e.g., baseband processor(s)). In embodiments, the transmit circuitry 1010 and/or receive circuitry 1015 may be elements or modules of transceiver circuitry, as shown. In some embodiments, the control circuitry 1020 can be in a device separate from the transmit circuitry 1010 and the receive circuitry 1015 (baseband processors shared by multiple antenna devices, as in cloud-RAN (C-RAN) implementations, for example). The electronic device circuitry 1000 may be coupled with one or more plurality of antenna elements 1025 of one or more antennas. The electronic device circuitry 1000 and/or the components of the electronic device circuitry 1000 may be configured to perform operations similar to those described elsewhere in this disclosure.

In embodiments where the electronic device circuitry 1000 is an eNB, BTS and/or a network node, or is incorporated into or is otherwise part of an eNB, BTS and/or a network node, the transmit circuitry 1010 can transmit the various described information (e.g., mobility control information, RRC message, DCI) to the UE. The receive circuitry 1015 can receive the various described information (e.g., PUCCH, PUSCH, etc.) from the UE. In certain embodiments, the electronic device circuitry 1000 shown in FIG. 10 is operable to perform one or more methods, such as the methods shown in FIGS. 7 and/or 8.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

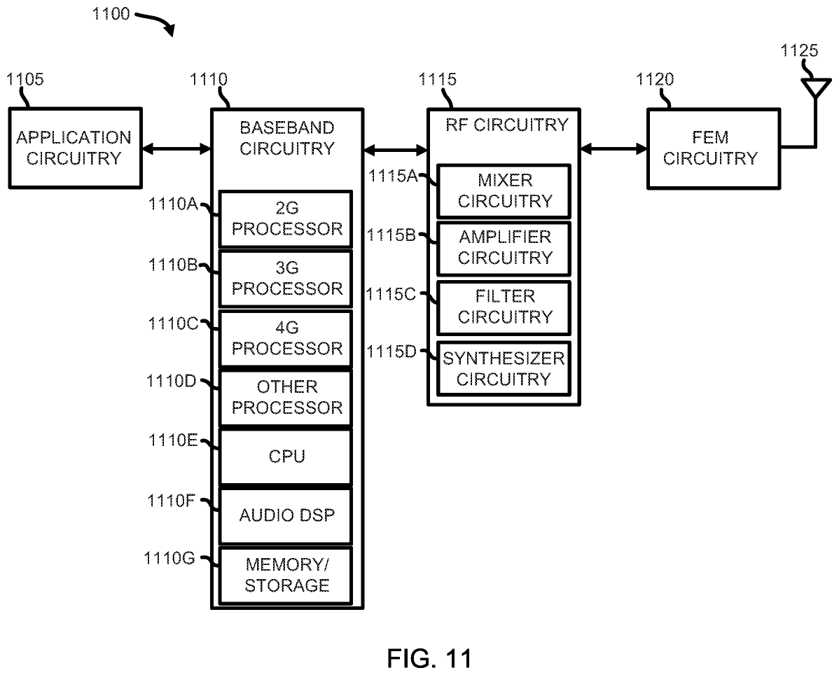

Embodiments described herein may be implemented into a system using any suitably configured hardware and/or software. FIG. 11 is a block diagram illustrating, for one embodiment, example components of a user equipment (UE) or mobile station (MS) device 1100. In some embodiments, the UE device 1100 may include application circuitry 1105, baseband circuitry 1110, Radio Frequency (RF) circuitry 1115, front-end module (FEM) circuitry 1120, and one or more antennas 1125, coupled together at least as shown in FIG. 11.

The application circuitry 1105 may include one or more application processors. By way of non-limiting example, the application circuitry 1105 may include one or more single-core or multi-core processors. The processor(s) may include any combination of general-purpose processors and dedicated processors (e.g., graphics processors, application processors, etc.). The processor(s) may be operably coupled and/or include memory/storage, and may be configured to execute instructions stored in the memory/storage to enable various applications and/or operating systems to run on the system.

By way of non-limiting example, the baseband circuitry 1110 may include one or more single-core or multi-core processors. The baseband circuitry 1110 may include one or more baseband processors and/or control logic. The baseband circuitry 1110 may be configured to process baseband signals received from a receive signal path of the RF circuitry 1115. The baseband 1110 may also be configured to generate baseband signals for a transmit signal path of the RF circuitry 1106. The baseband processing circuitry 1110 may interface with the application circuitry 1105 for generation and processing of the baseband signals, and for controlling operations of the RF circuitry 1115.

By way of non-limiting example, the baseband circuitry 1110 may include at least one of a second generation (2G) baseband processor 1110A, a third generation (3G) baseband processor 1110B, a fourth generation (4G) baseband processor 1110C, other baseband processor(s) 1110D for other existing generations, and generations in development or to be developed in the future (e.g., fifth generation (5G), 6G, etc.). The baseband circuitry 1110 (e.g., at least one of baseband processors 1110A-1110D) may handle various radio control functions that enable communication with one or more radio networks via the RF circuitry 1115. By way of non-limiting example, the radio control functions may include signal modulation/demodulation, encoding/decoding, radio frequency shifting, other functions, and combinations thereof. In some embodiments, modulation/demodulation circuitry of the baseband circuitry 1110 may be programmed to perform Fast-Fourier Transform (FFT), precoding, constellation mapping/demapping functions, other functions, and combinations thereof. In some embodiments, encoding/decoding circuitry of the baseband circuitry 1110 may be programmed to perform convolutions, tail-biting convolutions, turbo, Viterbi, Low Density Parity Check (LDPC) encoder/decoder functions, other functions, and combinations thereof. Embodiments of modulation/demodulation and encoder/decoder functions are not limited to these examples, and may include other suitable functions.

In some embodiments, the baseband circuitry 1110 may include elements of a protocol stack. By way of non-limiting example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 1110E of the baseband circuitry 1110 may be programmed to run elements of the protocol stack for signaling of the PHY, MAC, RLC, PDCP and/or RRC layers. In some embodiments, the baseband circuitry 1110 may include one or more audio digital signal processor(s) (DSP) 1110F. The audio DSP(s) 1110F may include elements for compression/decompression and echo cancellation. The audio DSP(s) 1110F may also include other suitable processing elements.

The baseband circuitry 1110 may further include memory/storage 1110G. The memory/storage 1110G may include data and/or instructions for operations performed by the processors of the baseband circuitry 1110 stored thereon. In some embodiments, the memory/storage 1110G may include any combination of suitable volatile memory and/or non-volatile memory. The memory/storage 1110G may also include any combination of various levels of memory/storage including, but not limited to, read-only memory (ROM) having embedded software instructions (e.g., firmware), random access memory (e.g., dynamic random access memory (DRAM)), cache, buffers, etc. In some embodiments, the memory/storage 1110G may be shared among the various processors or dedicated to particular processors.

Components of the baseband circuitry 1110 may be suitably combined in a single chip, a single chipset, or disposed on a same circuit board in some embodiments. In some embodiments, some or all of the constituent components of the baseband circuitry 1110 and the application circuitry 1105 may be implemented together, such as, for example, on a system on a chip (SOC).

In some embodiments, the baseband circuitry 1110 may provide for communication compatible with one or more radio technologies. For example, in some embodiments, the baseband circuitry 1110 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 1110 is configured to support radio communications of more than one wireless protocol may be referred to as multi-mode baseband circuitry.

The RF circuitry 1115 may enable communication with wireless networks using modulated electromagnetic radiation through a non-solid medium. In various embodiments, the RF circuitry 1115 may include switches, filters, amplifiers, etc. to facilitate the communication with the wireless network. The RF circuitry 1115 may include a receive signal path which may include circuitry to down-convert RF signals received from the FEM circuitry 1120, and provide baseband signals to the baseband circuitry 1110. The RF circuitry 1115 may also include a transmit signal path which may include circuitry to up-convert baseband signals provided by the baseband circuitry 1110, and provide RF output signals to the FEM circuitry 1120 for transmission.

In some embodiments, the RF circuitry 1115 may include a receive signal path and a transmit signal path. The receive signal path of the RF circuitry 1115 may include mixer circuitry 1115A, amplifier circuitry 1115B, and filter circuitry 1115C. The transmit signal path of the RF circuitry 1115 may include filter circuitry 1115C and mixer circuitry 1115A. The RF circuitry 1115 may further include synthesizer circuitry 1115D configured to synthesize a frequency for use by the mixer circuitry 1115A of the receive signal path and the transmit signal path. In some embodiments, the mixer circuitry 1115A of the receive signal path may be configured to down-convert RF signals received from the FEM circuitry 1120 based on the synthesized frequency provided by synthesizer circuitry 1115D. The amplifier circuitry 1115B may be configured to amplify the down-converted signals.

The filter circuitry 1115C may include a low-pass filter (LPF) or band-pass filter (BPF) configured to remove unwanted signals from the down-converted signals to generate output baseband signals. Output baseband signals may be provided to the baseband circuitry 1110 for further processing. In some embodiments, the output baseband signals may include zero-frequency baseband signals, although this is not a requirement. In some embodiments, the mixer circuitry 1115A of the receive signal path may comprise passive mixers, although the scope of the embodiments is not limited in this respect.

In some embodiments, the mixer circuitry 1115A of the transmit signal path may be configured to up-convert input baseband signals based on the synthesized frequency provided by the synthesizer circuitry 1115D to generate RF output signals for the FEM circuitry 1120. The baseband signals may be provided by the baseband circuitry 1110 and may be filtered by filter circuitry 1115C. The filter circuitry 1115C may include a low-pass filter (LPF), although the scope of the embodiments is not limited in this respect. In some embodiments, the mixer circuitry 1115A of the receive signal path and the mixer circuitry 1115A of the transmit signal path may include two or more mixers, and may be arranged for quadrature downconversion and/or upconversion, respectively. In some embodiments, the mixer circuitry 1115A of the receive signal path and the mixer circuitry 1115A of the transmit signal path may include two or more mixers and may be arranged for image rejection (e.g., Hartley image rejection). In some embodiments, the mixer circuitry 1115A of the receive signal path and the mixer circuitry 1115A may be arranged for direct downconversion and/or direct upconversion, respectively. In some embodiments, the mixer circuitry 1115A of the receive signal path and the mixer circuitry 1115A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In such embodiments, the RF circuitry 1115 may include analog-to-digital converter (ADC) and digital-to-analog converter (DAC) circuitry, and the baseband circuitry 1110 may include a digital baseband interface to communicate with the RF circuitry 1115.

In some dual-mode embodiments, separate radio IC circuitry may be provided for processing signals for each spectrum, although the scope of the embodiments is not limited in this respect.

In some embodiments, the synthesizer circuitry 1115D may include one or more of a fractional-N synthesizer and a fractional N/N+1 synthesizer, although the scope of the embodiments is not limited in this respect as other types of frequency synthesizers may be suitable. For example, synthesizer circuitry 1115D may include a delta-sigma synthesizer, a frequency multiplier, a synthesizer comprising a phase-locked loop with a frequency divider, other synthesizers, and combinations thereof.

The synthesizer circuitry 1115D may be configured to synthesize an output frequency for use by the mixer circuitry 1115A of the RF circuitry 1115 based on a frequency input and a divider control input. In some embodiments, the synthesizer circuitry 1115D may be a fractional N/N+1 synthesizer.

In some embodiments, frequency input may be provided by a voltage controlled oscillator (VCO), although that is not a requirement. Divider control input may be provided by either the baseband circuitry 1110 or the applications processor 1105 depending on the desired output frequency. In some embodiments, a divider control input (e.g., N) may be determined from a look-up table based on a channel indicated by the applications processor 1105.

The synthesizer circuitry 1115D of the RF circuitry 1115 may include a divider, a delay-locked loop (DLL), a multiplexer and a phase accumulator. In some embodiments, the divider may include a dual modulus divider (DMD), and the phase accumulator may include a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In such embodiments, the delay elements may be configured to break a VCO period up into Nd equal packets of phase, where Nd is the number of delay elements in the delay line. In this way, the DLL may provide negative feedback to help ensure that the total delay through the delay line is one VCO cycle.

In some embodiments, the synthesizer circuitry 1115D may be configured to generate a carrier frequency as the output frequency. In some embodiments, the output frequency may be a multiple of the carrier frequency (e.g., twice the carrier frequency, four times the carrier frequency, etc.) and used in conjunction with a quadrature generator and divider circuitry to generate multiple signals at the carrier frequency with multiple different phases with respect to each other. In some embodiments, the output frequency may be a LO frequency (fLO). In some embodiments, the RF circuitry 1115 may include an IQ/polar converter.

The FEM circuitry 1120 may include a receive signal path which may include circuitry configured to operate on RF signals received from one or more antennas 1125, amplify the received signals, and provide the amplified versions of the received signals to the RF circuitry 1115 for further processing. The FEM circuitry 1120 may also include a transmit signal path which may include circuitry configured to amplify signals for transmission provided by the RF circuitry 1115 for transmission by at least one of the one or more antennas 1125.

In some embodiments, the FEM circuitry 1120 may include a TX/RX switch configured to switch between a transmit mode and a receive mode operation. The FEM circuitry 1120 may include a receive signal path and a transmit signal path. The receive signal path of the FEM circuitry 1120 may include a low-noise amplifier (LNA) to amplify received RF signals and provide the amplified received RF signals as an output (e.g., to the RF circuitry 1115). The transmit signal path of the FEM circuitry 1120 may include a power amplifier (PA) configured to amplify input RF signals (e.g., provided by RF circuitry 1115), and one or more filters configured to generate RF signals for subsequent transmission (e.g., by one or more of the one or more antennas 1125.

In some embodiments, the MS device 1100 may include additional elements such as, for example, memory/storage, a display, a camera, one of more sensors, an input/output (I/O) interface, other elements, and combinations thereof.

In some embodiments, the MS device 1100 may be configured to perform one or more processes, techniques, and/or methods as described herein, or portions thereof.

### Examples

The following examples pertain to further embodiments.

Example 1 is an apparatus of a user equipment (UE). The apparatus includes one or more processors. The one or more processors obtain control information from a first evolved Node B (eNB), the control information including at least one random access parameter, determine a random access preamble index based on the at least one random access parameter, and generate a random access preamble for a second eNB based on the random access preamble index.

In Example 2, the apparatus of Example 1 or any of the Examples described herein can optionally initiate a random access transmission to the second eNB based on the obtained control information.

Example 3 is the apparatus of Examples 1 or 2 or any of the Examples described herein where the control information is included in a radio resource control (RRC) message.

Example 4 is the apparatus of Examples 1 or 2 or any of the Examples described herein where the control information is included in downlink control information (DCI).

Example 5 is the apparatus of Example 4 or any of the Examples described herein where a random access transmission is sent at a first PRACH transmission subframe after subframe n+g, where n is a subframe that the DCI is decoded in and g is a pre-defined decoding latency.

Example 6 is the apparatus of Example 1 or any of the Examples described herein where the at least one random access parameter is at least one of a beam reference signal (BRS) group identifier (ID) and a preamble index.

Example 7 is the apparatus of Example 1 or any of the Examples described herein where the random access preamble index is determined based on the BRS group ID and the preamble index.

Example 8 is the apparatus of Example 6 or any of the Examples described herein where the random access preamble index is determined by multiplying the BRS group ID (G) by a number of preamble indexes within one group (N_{g}) and then adding the preamble index (K), such that N_{Preamble}=G×N_{g}+K.

Example 9 is the apparatus of Example 6 or any of the Examples described herein where the at least one random access parameter is a cell radio network temporary identifier (C-RNTI) for the second eNB.

Example 10 is the apparatus of Example 6 or any of the Examples described herein where the BRS group ID is for the second eNB, and the at least one random access parameter further is a physical random access channel (PRACH) receiving power for the second eNB.

Example 11 is the apparatus of Example 1 or any of the Examples described herein where the random access preamble is a plurality of repeated Zadoff-Chu sequences for receive (RX) beam scanning at the second eNB.

In Example 12, the apparatus of Example 1 or any of the Examples described herein can optionally measure a BRS receive power (BRS-RP) of a plurality of transmit (TX) beams maintained by the second eNB, and select one of the plurality of TX beams based on the measured BRS-RP for each of the plurality of TX beams, where the random access preamble is generated for transmission on the selected TX beam.

Example 13 is the apparatus of Example 1 or any of the Examples described herein where the one or more processors is a baseband processor.

Example 14 is an apparatus for an evolved Node B (eNB). The apparatus includes one or more processors. The one or more processors identify a user equipment (UE) that is to communicate with a second eNB that is different than the eNB, and generate control information for the UE, the control information including at least one random access parameter, where the control information triggers the UE to transmit a random access preamble to the second eNB.

Example 15 is the apparatus of Example 14 or any of the Examples described herein where the at least one random access parameter is at least one of a beam reference signal (BRS) group identifier (ID) and a preamble index.

In Example 16, the apparatus of Example 14 or any of the Examples described herein can optionally determine a random access preamble index to be used by the UE, and select a beam reference signal (BRS) group identifier (ID) and a preamble index based on the determined random access preamble, where the at least one random access parameter is the selected BRS group ID and the selected preamble index.

Example 17 is the apparatus of Example 16 or any of the Examples described herein where the random access preamble index is determined by multiplying a BRS group ID (G) by a number of preamble indexes within one group (N_{g}) and then adding the preamble index (K), such that N_{Preamble}=G×N_{g}+K.

In Example 18, the apparatus of Examples 14 or 15 or any of the Examples described herein can optionally generate a radio resource control (RRC) message, where the control information is included in the RRC message.

In Example 19, the apparatus of Examples 14 or 15 or any of the Examples described herein can optionally generate downlink control information (DCI), where the control information is included in the DCI.

Example 20 is the apparatus of Example 14 or any of the Examples described herein where the at least one random access parameter comprises a cell radio network temporary identifier (C-RNTI) for the second eNB.

Example 21 is the apparatus of Example 14 or any of the Examples described herein where the at least one random access parameter is a physical random access channel (PRACH) receiving power for the second eNB.

Example 22 is the apparatus of Example 14 or any of the Examples described herein where the one or more processors is a baseband processor.

Example 23 is an apparatus of an evolved Node B (eNB). The apparatus includes one or more processors. The one or more processors obtain a random access preamble from the UE, where the random access preamble is based on the at least one random access parameter obtained from a second eNB that is different than the eNB, the random access preamble including multiple copies of a sequence, apply a different receive (RX) beam from a plurality of RX beams to each sequence in the random access preamble to determine a metric for each RX beam, and select at least one of the plurality of RX beams for multiple-input multiple-output (MIMO) communication based on the determined metric for each RX beam.

In Example 24, the apparatus of Example 23 or any of the Examples described herein can optionally determine at least one of a timing advance (TA) and a power control factor based on the obtained random access preamble.

Example 25 is the apparatus of Example 23 or any of the Examples described herein where the sequence is a Zadoff-Chu sequence.

Example 26 is the apparatus of Example 23 or any of the Examples described herein where each sequence in the multiple copies of the sequence has a same duration.

Example 27 is a method by a user equipment (UE) for wireless communication. The method includes obtaining control information from a first evolved Node B (eNB), the control information including at least one random access parameter, determining a random access preamble index based on the at least one random access parameter, and generating a random access preamble for a second eNB based on the random access preamble index.

In Example 28, the method of Example 27 or any of the Examples described herein can further include initiating a random access transmission to the second eNB based on the obtained control information.

Example 29 is the method of Example 27 or any of the Examples described herein where the control information is included in a radio resource control (RRC) message.

Example 30 is the method of Example 27 or any of the Examples described herein where the control information is included in downlink control information (DCI).

Example 31 is the method of Example 30 or any of the Examples described herein where a random access transmission is sent at a first PRACH transmission subframe after subframe n+g, where n is a subframe that the DCI is decoded in and g is a pre-defined decoding latency.

Example 32 is the method of Example 27 or any of the Examples described herein where the at least one random access parameter comprises at least one of a beam reference signal (BRS) group identifier (ID) and a preamble index.

Example 33 is the method of Example 32 or any of the Examples described herein where the random access preamble index is determined based on the BRS group ID and the preamble index.

Example 34 is the method of Example 32 or any of the Examples described herein where the random access preamble index is determined by multiplying the BRS group ID (G) by a number of preamble indexes within one group (N) and then adding the preamble index (K), such that N_{Preamble}=G×N_{g}+K.

Example 35 is the method of Example 32 or any of the Examples described herein where the at least one random access parameter comprises a cell radio network temporary identifier (C-RNTI) for the second eNB.

Example 36 is the method of Example 32 or any of the Examples described herein where the BRS group ID is for the second eNB, and the at least one random access parameter further is a physical random access channel (PRACH) receiving power for the second eNB.

Example 37 is the method of Example 27 or any of the Examples described herein where the random access preamble comprises a plurality of repeated Zadoff-Chu sequences for receive (RX) beam scanning at the second eNB.

In Example 38, the method of Example 27 or any of the Examples described herein further include measuring a BRS receive power (BRS-RP) of a plurality of transmit (TX) beams maintained by the second eNB, and selecting one of the plurality of TX beams based on the measured BRS-RP for each of the plurality of TX beams, where the random access preamble is generated for transmission on the selected TX beam.

Example 39 is a method by an evolved Node B (eNB) for wireless communication. The method includes identifying a user equipment (UE) that is to communicate with a second eNB that is different than the eNB, and generating control information for the UE, the control information including at least one random access parameter, where the control information triggers the UE to transmit a random access preamble to the second eNB.

Example 40 is the method of Example 39 or any of the Examples described herein where at least one random access parameter is at least one of a beam reference signal (BRS) group identifier (ID) and a preamble index.

In Example 41, the method of Example 39 or any of the Examples described can further include determining a random access preamble index to be used by the UE, and selecting a beam reference signal (BRS) group identifier (ID) and a preamble index based on the determined random access preamble, where the at least one random access parameter is the selected BRS group ID and the selected preamble index.

Example 42 is the method of Example 41 or any of the Examples described herein where the random access preamble index is determined by multiplying a BRS group ID (G) by a number of preamble indexes within one group (N_{g}) and then adding the preamble index (K), such that N_{Preamble}=G×N_{g}+K.

In Example 43, the method of Example 39 or any of the Examples described can further include generating a radio resource control (RRC) message, where the control information is included in the RRC message.

In Example 44, the method of Example 39 or any of the Examples described can further include generating downlink control information (DCI), where the control information is included in the DCI.

Example 45 is the method of Example 39 or any of the Examples described herein where the at least one random access parameter comprises a cell radio network temporary identifier (C-RNTI) for the second eNB.

Example 46 is the method of Example 39 or any of the Examples described herein where the at least one random access parameter comprises a physical random access channel (PRACH) receiving power for the second eNB.

Example 47 is a method by an evolved Node B (eNB) for wireless communication. The method includes obtaining a random access preamble from the UE, where the random access preamble is based on the at least one random access parameter obtained from a second eNB that is different than the eNB, the random access preamble including multiple copies of a sequence, applying a different receive (RX) beam from a plurality of RX beams to each sequence in the random access preamble to determine a metric for each RX beam, and selecting at least one of the plurality of RX beams for multiple-input multiple-output (MIMO) communication based on the determined metric for each RX beam.

In Example 48, the method of Example 47 or any of the Examples described can further include determining at least one of a timing advance (TA) and a power control factor based on the obtained random access preamble.

Example 49 is the method of Example 47 or any of the Examples described herein where the sequence is a Zadoff-Chu sequence.

Example 50 is the method of Example 47 or any of the Examples described herein where each sequence in the multiple copies of the sequence has a same duration.

Example 51 is an apparatus that includes means to perform the method of any of the Examples described herein.

Example 52 is machine-readable storage including machine-readable instructions, that when executed, cause a processor to implement a method or realize an apparatus as described in any of the Examples described herein.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a non-transitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general purpose device, such as an Intel®, AMD®, or other “off-the-shelf” microprocessor. The processor may include a special purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of embodiments of the disclosure. One skilled in the relevant art will recognize, however, that the disclosure may be practiced without one or more of the specific details, or with other methods, components, materials, etc. In other instances, well-known structures, materials, or operations are not shown or described in detail to avoid obscuring aspects of the disclosure.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the disclosure is not to be limited to the details given herein, but may be modified within the scope and equivalents of the appended claims.

Those having skill in the art will appreciate that many changes may be made to the details of the above-described embodiments without departing from the underlying principles of the disclosure. The scope of the present disclosure should, therefore, be determined only by the following claims.

1-25. (canceled)

26. An apparatus of a user equipment (UE), the apparatus comprising:
one or more processors to:
obtain control information from a first evolved Node B (eNB), the control information including at least one random access parameter;
determine a random access preamble index based on the at least one random access parameter; and
generate a random access preamble for a second eNB based on the random access preamble index.

27. The apparatus of claim 26, wherein the one or more processors are further to:
initiate a random access transmission to the second eNB based on the obtained control information.

28. The apparatus of claim 26, wherein the control information is included in a radio resource control (RRC) message.

29. The apparatus of claim 26, wherein the control information is included in downlink control information (DCI).

30. The apparatus of claim 29, wherein a random access transmission is sent at a first PRACH transmission subframe after subframe n+g, where n is a subframe that the DCI is decoded in and g is a pre-defined decoding latency.

31. The apparatus of claim 26, wherein the at least one random access parameter comprises at least one of a beam reference signal (BRS) group identifier (ID), a preamble index, and a cell radio network temporary identifier (C-RNTI).

32. The apparatus of claim 31, wherein the random access preamble index is determined by multiplying the BRS group ID (G) by a number of preamble indexes within one group (N_{g}) and then adding the preamble index (K), such that N_{Preamble}=G×N_{g}+K.

33. The apparatus of claim 31, wherein the BRS group ID is for the second eNB, and the at least one random access parameter further comprises a physical random access channel (PRACH) receiving power for the second eNB.

34. The apparatus of claim 26, wherein the random access preamble comprises a plurality of repeated Zadoff-Chu sequences for receive (RX) beam scanning at the second eNB.

35. The apparatus of claim 26, wherein the one or more processors are further to:
measure a BRS receive power (BRS-RP) of a plurality of transmit (TX) beams maintained by the second eNB; and
select one of the plurality of TX beams based on the measured BRS-RP for each of the plurality of TX beams, wherein the random access preamble is generated for transmission on the selected TX beam.

36. A non-transitory computer-readable medium having instructions stored thereon, the instructions, when executed by a computing device, cause the computing device to:
obtain control information from a first evolved Node B (eNB), the control information including at least one random access parameter;
determine a random access preamble index based on the at least one random access parameter; and
generate a random access preamble for a second eNB based on the random access preamble index.

37. The computer-readable medium of claim 36, wherein the instructions further cause the computing device to:
initiate a random access transmission to the second eNB based on the obtained control information.

38. The computer-readable medium of claim 36, wherein the instructions further cause the computing device to:
measure a BRS receive power (BRS-RP) of a plurality of transmit (TX) beams maintained by the second eNB; and
select one of the plurality of TX beams based on the measured BRS-RP for each of the plurality of TX beams, wherein the random access preamble is generated for transmission on the selected TX beam.

39. An apparatus for an evolved Node B (eNB), the apparatus comprising:
one or more processors to:
identify a user equipment (UE) that is to communicate with a second eNB that is different than the eNB; and
generate control information for the UE, the control information including at least one random access parameter, wherein the control information triggers the UE to transmit a random access preamble to the second eNB.

40. The apparatus of claim 39, wherein the at least one random access parameter comprises at least one of a beam reference signal (BRS) group identifier (ID), a preamble index, and a cell radio network temporary identifier (C-RNTI).

41. The apparatus of claim 39, wherein the one or more processors are further to:
determine a random access preamble index to be used by the UE; and
select a beam reference signal (BRS) group identifier (ID) and a preamble index based on the determined random access preamble, wherein the at least one random access parameter comprises the selected BRS group ID and the selected preamble index.

42. The apparatus of claim 39, wherein the one or more processors are further to:
generate a radio resource control (RRC) message, wherein the control information is included in the RRC message.

43. The apparatus of claim 39, wherein the one or more processors are further to:
generate downlink control information (DCI), wherein the control information is included in the DCI.

44. A non-transitory computer-readable medium having instructions stored thereon, the instructions, when executed by a computing device, cause the computing device to:
identify a user equipment (UE) that is to communicate with a second eNB that is different than the eNB; and
generate control information for the UE, the control information including at least one random access parameter, wherein the control information triggers the UE to transmit a random access preamble to the second eNB.

45. The computer-readable medium of claim 44, wherein the instructions further cause the computing device to:
determining a random access preamble index to be used by the UE; and
selecting a beam reference signal (BRS) group identifier (ID) and a preamble index based on the determined random access preamble, wherein the at least one random access parameter comprises the selected BRS group ID and the selected preamble index.

46. The computer-readable medium of claim 44, wherein the instructions further cause the computing device to:
generating at least one of a radio resource control (RRC) message and downlink control information (DCI), wherein the control information is included in at least one of the RRC message and the DCI.
